(19) United States
(12) Patent Application Publication
(10) Pub. No.: US 2025/0388179 A1
(43) Pub. Date: Dec. 25, 2025

(54) COMPUTER STAND

(71) Applicant: Punengyuancheng (Tianjin) Technology Co., Ltd., Tianjin (CN)

(72) Inventor: Hao Wang, Tianjin (CN)

(21) Appl. No.: 19/240,233

(22) Filed: Jun. 17, 2025

(30) Foreign Application Priority Data
Jun. 21, 2024 (CN) 202421437323.2

(51) Int. Cl. B60R 11/02; B60R 11/00; G06F 1/16

(52) U.S. Cl. CPC B60R 11/0252; G06F 1/1633; B60R 2011/001; B60R 2011/0057; B60R 2011/0082

(57) ABSTRACT

A computer stand. The computer stand includes a main support, configured to support a computer. The main support is arranged with an auxiliary-support magnetic interface, and the auxiliary-support magnetic interface includes an auxiliary-support magnetic surface and an auxiliary-support support portion. The auxiliary-support magnetic surface is configured for a magnetic connection with an auxiliary support; the auxiliary-support support portion is configured for a separable limit-mating with the auxiliary support and is further configured to provide a support force to the auxiliary support around a length direction of the auxiliary-support magnetic surface. The computer stand may enable quick disassembly from the auxiliary support via the auxiliary-support magnetic interface. The support portion of the main support can provide support to the auxiliary support, preventing the auxiliary support from easily detaching from the auxiliary-support magnetic surface, thereby preventing the auxiliary support from easily falling off the main support.

### CROSS-REFERENCE TO RELATED APPLICATIONS

The present application claims the priority of Chinese patent application No. 202421437323.2, filed on Jun. 21, 2024, and the entire contents of which are hereby incorporated by reference in its entirety.

### TECHNICAL FIELD

The present disclosure relates to the technical field of office supplies, and more specifically to a computer stand.

### BACKGROUND

Temporary use of laptops during parking has become a prevalent demand for mobile professionals. The market offers diverse vehicular-mounted computer desks, among which a significant category involves steering wheel-mounted platforms or supports. As the steering wheel represents the sole ergonomically designed interface in vehicles specifically optimized for dual-hand frontal operation, positioning a laptop in this area ensures optimal comfort for typing and professional tasks. In existing technical implementations, such computer stands are not only equipped with primary supports for laptops but also feature auxiliary supports to accommodate mobile terminals including mobile phones, tablets, and external displays. However, in the related art, the connection between the auxiliary support and the main support of the computer stand predominantly employs either permanent fixation or mechanical snap-in mechanisms, resulting in inconvenient disassembly of the auxiliary support from the computer stand.

### SUMMARY OF THE DISCLOSURE

The present disclosure provides a computer stand, including:
a main support, configured to support a computer; wherein the main support is arranged with an auxiliary-support magnetic interface that is long strip-shaped, and the auxiliary-support magnetic interface includes an auxiliary-support magnetic surface and an auxiliary-support support portion that both extend along a length direction of the auxiliary-support magnetic interface;
wherein the auxiliary-support magnetic surface is configured for a magnetic connection with an auxiliary support; at least one of two sides of the auxiliary-support magnetic surface along a width direction is arranged with the auxiliary-support support portion; the auxiliary-support support portion is configured for a separable limit-mating with the auxiliary support and is further configured to provide a support force to the auxiliary support around a length direction of the auxiliary-support magnetic surface.

In some embodiments, the two sides of the auxiliary-support magnetic surface along the width direction are each arranged with the auxiliary-support support portion.

In some embodiments, for two the auxiliary-support support portions on the two sides of the auxiliary-support magnetic surface, one of the two auxiliary-support support portions is configured to provide the support force to the auxiliary support around the length direction of the auxiliary-support magnetic surface, and the one of the two auxiliary-support support portions and the other of the two auxiliary-support support portions cooperate together to limit the auxiliary support along the width direction of the auxiliary-support magnetic surface.

In some embodiments, the main support includes two brackets that are arranged side-by-side and a length-adjustable frame disposed between the two brackets;
each bracket includes a support plate; the support plate extends to form a long-strip shape;
each bracket is arranged with a steering-wheel mounting portion for hanging the computer stand on a steering wheel;
two the support plates of the two brackets are connected by the length-adjustable frame; the support plate includes a support surface for supporting a computer; the auxiliary-support magnetic interface is arranged on a surface of the support plate avoiding the support surface, and the length direction of the auxiliary-support magnetic interface is consistent with a length direction of the support plate.

In some embodiments, each bracket further includes a base plate and a support arm disposed between the base plate and the support plate, and the base plate extends to form a long strip shape; a hinged end of the base plate is hinged to an end of the support plate, and the base plate is arranged with the steering-wheel mounting portion on the hinged end; an end of the support arm is hinged to one of the base plate and the support plate, and another end of the support arm is inserted into the other of the base plate and the support plate.

In some embodiments, the support plate includes a mounting back surface opposite the support surface;
the auxiliary-support magnetic interface is disposed on the mounting back surface; or, the auxiliary-support magnetic interface is disposed at a connection between the mounting back surface and a side surface of the support plate.

In some embodiments, at least one the auxiliary-support magnetic interface is arranged on each of the two support plates.

In some embodiments, the computer stand further includes an auxiliary support for supporting a mobile terminal; wherein the auxiliary support is arranged with a magnetic docking portion adapted to the auxiliary-support magnetic docking interface, and the magnetic docking portion includes a magnetic mating surface and a support mating portion; the magnetic mating surface is magnetically mated with the auxiliary-support magnetic surface, and the support mating portion is limitingly mated with the auxiliary-support support portion along at least one of the width direction and a magnetic attraction direction of the magnetic mating surface.

In some embodiments, the support mating portion includes a second flange disposed on a side of the magnetic mating surface along the width direction, and the second flange protrudes along the width direction of the magnetic mating surface and is spaced apart from the magnetic mating surface in the magnetic attraction direction;
the auxiliary-support support portion includes a first limiting edge that is sandwiched between the second flange and the magnetic mating surface.

In some embodiments, the support mating portion further includes a first flange protruding along the magnetic attraction direction of the magnetic mating surface; the first flange is disposed on one of both sides of the magnetic mating surface in the width direction, and the second flange is disposed on the other of the both sides of the magnetic mating surface in the width direction; the auxiliary-support support portion further includes a second limiting edge, and the first flange is disposed on a side of the second limiting edge away from the second flange, for limiting the auxiliary support in the width direction of the magnetic mating surface.

In some embodiments, the magnetic docking portion is embedded with a main magnetic attachment member and a side magnetic attachment member that both extend along a length direction of the magnetic docking portion, and the main magnetic attachment member is disposed facing the auxiliary-support magnetic surface in the magnetic attraction direction of the auxiliary-support magnetic surface; the side magnetic attachment member is adjacent to the second flange and is disposed in correspondence with and facing the first limiting edge.

In some embodiments, a length of the magnetic interface is greater than a length of the magnetic mating surface, and the auxiliary support is caused to be slidable magnetically along the length direction of the auxiliary-support magnetic interface.

In some embodiments, the auxiliary support includes a first plate and a second plate that are damped hinged to each other; the first plate is arranged with the magnetic docking portion, and the second plate is arranged with a mobile-terminal magnetic portion.

### BRIEF DESCRIPTION OF THE DRAWINGS

To more clearly illustrate the technical solutions of the embodiments of the present disclosure or the related art, the following is a brief introduction to the drawings used in the description of the embodiments or the related art. It is obvious that the drawings described below are only some embodiments of the present disclosure. For those skilled in the art, other drawings can be obtained based on the structures shown in these drawings without creative labor.

FIG. 1 is a structural schematic view of a computer stand according to some embodiments of the present disclosure.

FIG. 2 is a disassembled schematic view of a main support and an auxiliary support of the computer stand shown in FIG. 1.

FIG. 3 is a structural schematic view of an auxiliary support according to some embodiments of the present disclosure.

FIG. 4 is a cross-sectional schematic view of an auxiliary support and a magnetic interface of the auxiliary support according to some embodiments of the present disclosure.

FIG. 5 is an enlarged view of an area A circumscribed in FIG. 4.

FIG. 6 is a disassembled schematic view of a magnetic interface of an auxiliary support according to some embodiments of the present disclosure.

FIG. 7 is a cross-sectional schematic view of an auxiliary support and a magnetic interface of the auxiliary support according to other embodiments of the present disclosure.

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without creative labor fall within the scope of the present disclosure.

It should be noted that when the embodiments of the present disclosure involve directional indications (such as up, down, left, right, forward, back . . . ), the directional indications are only intended to explain a relative positional relationship, a movement, etc. between the various components in a particular attitude. When the particular attitude changes, the directional indications are also changed accordingly.

In addition, when the embodiments of the present disclosure contain descriptions involving “first”, “second”, etc., the descriptions of “first”, “second”, etc. are intended only for descriptive purposes, and are not to be construed as indicating or implying their relative importance or implicitly specifying the number of the indicated technical features. That is, a feature defined as “first” or “second” may include at least one such feature either explicitly or implicitly. In addition, the meaning of “and/or” in the whole text is to include three concurrent solutions. For example, “A and/or B” includes an A solution, a B solution, and a solution in which A and B are satisfied at the same time. In addition, the technical solutions of different embodiments can be combined with each other, but they must be based on what is achievable by those skilled in the art. When the combination of technical solutions is contradictory or unachievable, such combination of technical solutions shall be deemed not to exist and shall not be included in the scope of protection claimed by the present disclosure.

The present disclosure proposes a computer stand, which is intended to solve the technical problem of how to improve the effectiveness of computer stands.

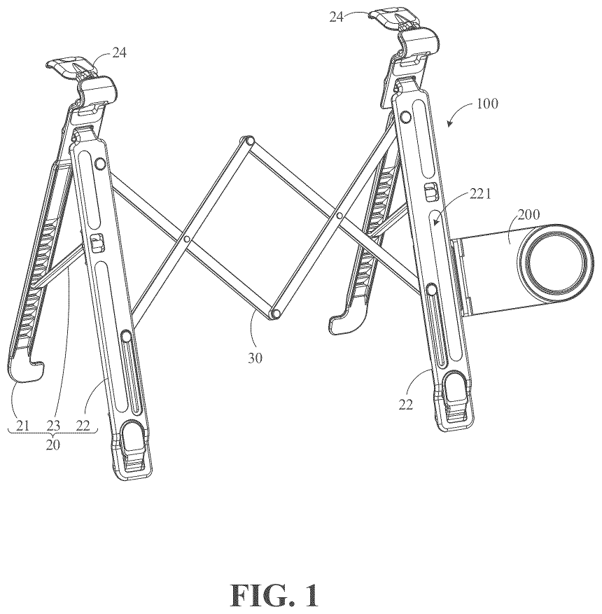

In the embodiments of the present disclosure, as shown in FIGS. 1 to 7, the computer stand includes: a main support 100, which is configured to support a computer; the main support 100 is arranged with an auxiliary-support magnetic interface 10 that is long strip-shaped, and the auxiliary-support magnetic interface 10 includes an auxiliary-support magnetic surface 11 and an auxiliary-support support portion 12 that both extend along a length direction of the auxiliary-support magnetic interface 10; the auxiliary-support magnetic surface 11 is configured for a magnetic connection with an auxiliary support 200; at least one side of the auxiliary-support magnetic surface 11 along a width direction is arranged with the auxiliary-support support portion 12; the auxiliary-support support portion 12 is configured for a separable limit-mating with the auxiliary support 200 and is further configured to provide a support force to the auxiliary support 200 around a length direction of the auxiliary-support magnetic surface 11.

In the embodiments, the specific shape of the main support 100 is not limited, as long as it can support a laptop computer. The auxiliary-support magnetic interface 10 is configured for a detachable magnetic connection with the auxiliary support 200, such that the auxiliary support 200 can be mounted on the main support 100 or removed from the main support 100 according to actual needs of the user. The auxiliary support 200 is configured to support a mobile device such as a mobile phone, a tablet, and an external display. For the sake of clarity, the following description takes a mobile phone as an example of the mobile device. After the user mounts the auxiliary support 200 onto the auxiliary-support magnetic interface 10, he/she may place the mobile phone on the auxiliary support 200, thereby allowing the laptop computer and the mobile phone to be positioned simultaneously in front of the user, which enables a dual-screen operation on the computer and the mobile phone.

The auxiliary support 200 can be magnetically attached to the auxiliary-support magnetic surface 11, while the auxiliary-support support portion 12 provides support and positioning for the auxiliary support 200, thereby preventing the auxiliary support 200 from directly detaching from the auxiliary-support magnetic interface 10 along a magnetic connection direction or along a width direction of the auxiliary-support magnetic surface 11 when force is applied to the auxiliary support 200, which may improve the stability of the fit between the auxiliary support 200 and the auxiliary-support magnetic interface 10, prevent the auxiliary support 200 from easily detaching from the main support 100, improve the effectiveness of the computer stand, and improve the user experience. It should be understood that the auxiliary-support support portion 12 includes a support surface facing the auxiliary-support magnetic surface 11 and spaced apart from the auxiliary-support magnetic surface 11. By engaging the auxiliary support 200 with the support surface in the magnetic attraction direction of the auxiliary-support magnetic surface 11, part of the gravitational force of the auxiliary support 200 is distributed onto the auxiliary-support support portion 12.

It should be noted that if the auxiliary support 200 and the main support 100 are connected only by increasing the magnetic attraction to ensure the stability of the connection between the two, a large force is required to remove and mount the auxiliary support 200 during daily use, which is inconvenient and affects the user experience. However, if the magnetic attraction between the auxiliary support 200 and the main support 100 is reduced, the auxiliary support 200 will easily fall off the main support 100 after carrying the electronic device.

In the technical solutions of the computer stand as proposed in the present disclosure, a long strip-shaped auxiliary-support magnetic interface 10 is provided on the main support 100, and the auxiliary support 200 can support a mobile terminal such as a mobile phone, a tablet, and an external screen, such that the computer stand can simultaneously support a laptop computer and a mobile terminal such as a mobile phones to meet the needs of multi-screen use. The auxiliary support 200 is magnetically connected to the main support 100, and the connection structure between the two is simple, making it more convenient to assemble and disassemble. In addition, the strip-shaped auxiliary-support magnetic interface 10 not only meets the magnetic connection requirements of the auxiliary support 200, but also reduces the width occupied by the auxiliary-support magnetic interface 10, thereby ensuring the overall consistency of the appearance of the main support 100.

On the auxiliary-support magnetic interface 10, an auxiliary-support magnetic surface 11 and an auxiliary-support support portion 12 are provided. The auxiliary-support magnetic surface 11 allows the auxiliary support 200 to be magnetically connected, while the auxiliary-support support portion 12 limits the movement of the auxiliary support 200. This design may enable the auxiliary-support support portion 12 to provide support force to the auxiliary support 200 around the length direction of the auxiliary support 200. On one hand, the auxiliary support 200 may be prevented from twisting and deviating from the auxiliary-support magnetic interface 10, and on the other hand, the auxiliary-support support portion 12 may withstand significant lateral pulling forces, thereby increasing the load-bearing capacity of the auxiliary-support magnetic interface 10 when suspending heavy tablets or external screens. This may prevent the auxiliary support 200 from easily detaching from the auxiliary-support magnetic surface 11, thereby preventing the auxiliary support 200 from easily falling off the main support 100. In this way, while reducing the magnetic force between the auxiliary-support magnetic interface 10 and the auxiliary support 200, the connection stability between the auxiliary support 200 and the main support 100 is ensured, making it more convenient for users to disassemble the auxiliary support 200 and thereby improving the usability of the computer stand.

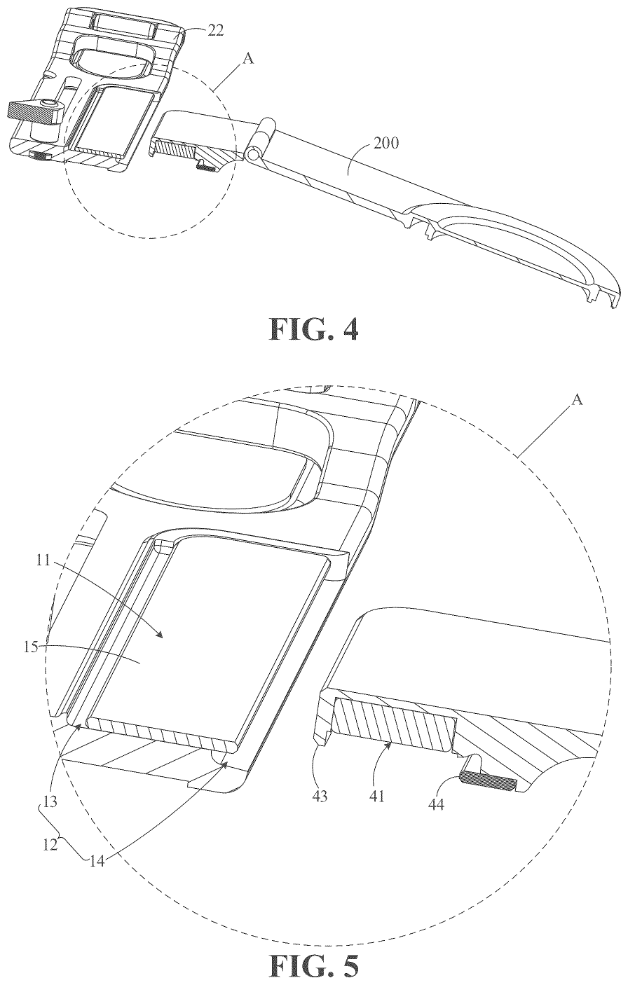

Furthermore, as shown in FIGS. 4, 5, and 7, the two sides of the auxiliary-support magnetic surface 11 in the width direction are each arranged with the auxiliary-support support portion 12. This allows both the auxiliary-support support portions 12 to provide support force to the auxiliary support 200 around the length direction of the auxiliary-support magnetic surface 11. Alternatively, one of the auxiliary-support support portions 12 may be configured to provide support force to the auxiliary support 200 around the length direction of the auxiliary-support magnetic surface 11, and the other auxiliary-support support portion 12 may support the auxiliary support 200 in another direction, such as the width direction of the auxiliary-support magnetic surface 11. By providing the auxiliary-support support portions 12 on both sides of the auxiliary-support magnetic surface 11 in the width direction, the support limiting area of the auxiliary-support magnetic interface 10 is increased, thereby enhancing the connection stability between the auxiliary support 200 and the auxiliary-support magnetic interface 10.

Furthermore, one of the auxiliary-support support portions 12 is configured to provide support force to the auxiliary support 200 around the length direction of the auxiliary-support magnetic surface 11, and the auxiliary-support support portion 12 and the other auxiliary-support support portion 12 cooperate together to limit the auxiliary support 200 in the width direction of the auxiliary-support magnetic surface 11.

In the embodiments, one of the auxiliary-support support portions 12 is configured to provide support force to the auxiliary support 200 around the length direction of the auxiliary-support magnetic surface 11, thereby distributing most of the gravitational force of the auxiliary support 200 onto the auxiliary-support support portion 12, which may reduce the magnetic attraction force between the auxiliary-support magnetic surface 11 and the auxiliary support 200, thereby improving the ease of assembly and disassembly of the auxiliary support 200 and the auxiliary-support magnetic interface 10. The other auxiliary-support support portion 12 and the above auxiliary-support support portion 12 together limit the auxiliary support 200 in the width direction of the auxiliary-support magnetic surface 11, thereby effectively preventing the auxiliary support 200 from detaching from the main support 100 in the width direction of the auxiliary-support magnetic surface 11. In this way, one of the auxiliary-support support portions 12 primarily serves a supporting function, while the other auxiliary-support support portion 12 primarily serves a limiting function, thereby effectively preventing the auxiliary support 200 from twisting and deviating from the auxiliary-support magnetic interface 10. That is, the connection stability and reliability between the auxiliary support 200 and the auxiliary-support magnetic interface 10 may be further enhanced.

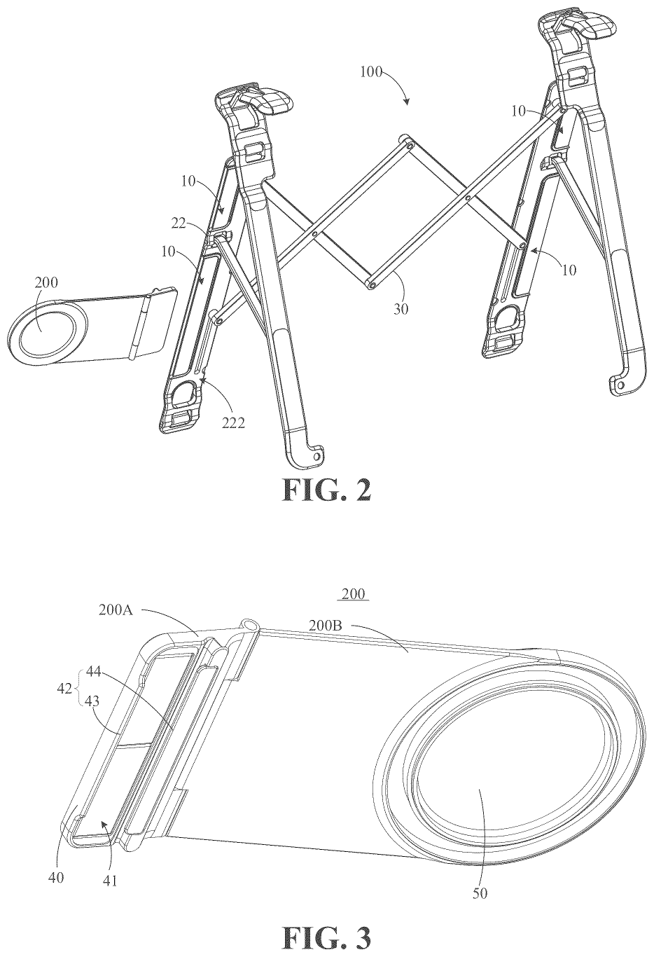

Specifically, as shown in FIGS. 1 and 2, the main support 100 includes two brackets 20 that are arranged side-by-side and a length-adjustable frame 30 disposed between the two brackets 20; each bracket 20 includes a support plate 22; the support plate 22 extends to form a long-strip shape; each bracket 20 is arranged with a steering-wheel mounting portion 24 for hanging the computer stand on a steering wheel; the two support plates 22 of the two brackets 20 are connected by the length-adjustable frame 30; the support plate 22 includes a support surface 221 for supporting the computer; the auxiliary-support magnetic interface 10 is arranged on a surface of the support plate 22 avoiding the support surface 221, and the length direction of the auxiliary-support magnetic interface 10 is consistent with a length direction of the support plate 22.

In the embodiments, the computer stand is arranged with a steering-wheel mounting portion 24, enabling it to be mounted on the steering wheel for use, thereby meeting the user's needs for using the computer inside a vehicle. Since the support surface 221 is intended for placing the computer, the auxiliary-support magnetic interface 10 should be positioned in avoidance with the support surface 221 to prevent the computer from obstructing the auxiliary support 200. The length-adjustable frame 30 has its length adjustable in an arrangement direction of the two brackets 20, allowing the distance between the two brackets 20 to be adjusted, thereby enabling the computer stand to accommodate laptops of different lengths and thus improving usability. Furthermore, a carrying portion may be arranged on an end of each support plate 22 away from the steering-wheel mounting portion 24. Thus, when the computer is placed on the support surface 221 of the support plate 22, the bottom of the computer is supported by the two carrying portions, preventing the computer from slipping.

The main support with the above configuration is foldable, making it more convenient to carry and store. Since the support plate 22 of the main support is long strip-shaped, the length direction of the auxiliary-support magnetic interface 10 is consistent with the length direction of the support plate 22, which makes full use of the length dimension of the support plate 22 and eliminates the need for an additional structure to arrange the auxiliary-support magnetic interface 10, thereby simplifying the overall structure of the computer stand. Applying the computer stand of the present disclosure in a vehicle not only improves the convenience of disassembly and assembly of the auxiliary support 200 and the main support 100, but also improves the connection stability of the auxiliary support 200 and the main support 100, so as to resist the jolts of the vehicle.

More specifically, the bracket 20 further includes a base plate 21 and a support arm 23 disposed between the base plate 21 and the support plate 22, and the base plate 21 extends to form a long strip shape; an end of the base plate 21 is hinged to an end of the support plate 22, and the base plate 21 is arranged with the steering-wheel mounting portion 24 at the hinged end; an end of the support arm 23 is hinged to one of the base plate 21 and the support plate 22, and the other end of the support arm 23 is inserted into the other of the base plate 21 and the support plate 22.

In the embodiments, after the support plate 22 is opened to a predetermined angle, by inserting the support arm 23 into the base plate 21, the angle between the support plate 22 and the base plate 21 may be maintained at the predetermined angle. When the computer stand is mounted on the steering wheel through the steering-wheel mounting portion 24, the base plate 21 abuts against the steering wheel, and the support surface 221 of the support plate 22 is disposed on a side of the support plate 22 away from the base plate 21. The support plate 22 is disposed on a side of the base plate 21 away from the steering wheel. The support plate 22 is angled relative to the base plate 21, and the angle of the support plate 22 relative to the base plate 21 is adjustable to allow the computer stand to support the laptop computer at different angles, for meet the user's needs. Additionally, the computer stand may further be placed on a desk for use.

In actual use, as shown in FIG. 2, the support plate 22 includes a mounting back surface 222 opposite the support surface 221; the auxiliary-support magnetic interface 10 is disposed on the mounting back surface 222; or, the auxiliary-support magnetic interface 10 is disposed at a connection between the mounting back surface 222 and a side surface of the support plate 22. In this way, even if a laptop computer is already placed on the support surface 221, the user can mount the auxiliary support 200 on the back side of the support plate 22 without first removing the laptop computer, thereby enhancing the user's operational convenience. Additionally, positioning the auxiliary-support magnetic interface 10 on the mounting back surface 222 of the support plate 22 or at the connection between the mounting back surface 222 and the side surface of the support plate 22 allows the auxiliary-support magnetic interface 10 to be hidden, thereby resulting in a cleaner overall appearance of the computer stand.

For example, as shown in FIG. 2, at least one auxiliary-support magnetic interface 10 is arranged on each of the two support plates 22. When the computer stand is in use, the two support plates 22 are arranged left and right relative to the user, and the two support plates 22 are each provided with the auxiliary-support magnetic interface 10, which is adapted to both left-handed and right-handed users, allowing users to choose to mount the auxiliary support 200 on the auxiliary-support magnetic interface 10 of the left support plate 22 or the auxiliary-support magnetic interface 10 of the right support plate 22 according to their actual needs. Of course, for users who need to use two mobile phones, the auxiliary support 200 can be mounted on each of the auxiliary-support magnetic interfaces 10 of the two support plates 22 to support two mobile phones separately.

For example, as shown in FIG. 3, the computer stand further includes an auxiliary support 200 for supporting a mobile terminal; the auxiliary support 200 is arranged with a magnetic docking portion 40 adapted to the auxiliary-support magnetic interface 10, where the magnetic docking portion 40 includes a magnetic mating surface 41 and a support mating portion 42; the magnetic mating surface 41 is magnetically mated with the auxiliary-support magnetic surface 11, and the support mating portion 42 is limitingly mated with the auxiliary-support support portion 12 in the width direction and/or magnetic attraction direction of the magnetic mating surface 41.

In the embodiments, the magnetic mating surface 41 is magnetically mated with the auxiliary-support magnetic surface 11, thereby achieving a fixed connection between the auxiliary support 200 and the main support 100. The support mating portion 42 is mated with the auxiliary-support support portion 12, such that when a force acting on the auxiliary support 200 along the width direction and/or magnetic attraction direction of the magnetic mating surface 41 exceeds the magnetic attraction force, the auxiliary support 200 is prevented from directly separating from the auxiliary-support magnetic surface 11 along the width direction and/or magnetic attraction direction of the magnetic mating surface 41, thereby limiting the movement of the auxiliary support 200, and thus improving the mounting stability of the auxiliary support 200 and the main support 100.

In addition, the auxiliary support 200 and the main support 100 are only magnetically coupled through the magnetic mating surface 41 and the auxiliary-support magnetic surface 11, and can be separated and limited by the support mating portion 42 and the auxiliary-support support portion 12, making the auxiliary support 200 and the main support 100 easier and faster to disassemble. In actual use, the auxiliary support 200 may further be removed from the main support 100 and attached to a rearview mirror to hold an external screen, thereby achieving a dual-screen office function. The auxiliary support 200 may further be magnetically attached to a dashboard or behind a central control screen, enabling the auxiliary support 200 to serve multiple purposes, while also addressing the issue of where to store the auxiliary support 200.

In some embodiments, referring to FIG. 7, the support mating portion 42 includes a second flange 44 disposed on a side of the magnetic mating surface 41 in the width direction, the second flange 44 protrudes along the width direction of the magnetic mating surface 41 and is spaced apart from the magnetic mating surface 41 in the magnetic attraction direction.

The auxiliary-support support portion 12 includes a first limiting edge 17, which is sandwiched between the second flange 44 and the magnetic mating surface 41.

In the embodiments, the second flange 44 protrudes in the width direction of the magnetic mating surface 41 and is spaced apart from the magnetic mating surface 41 in the magnetic attraction direction, such that a hanging slot is defined between the second flange 44 and the magnetic mating surface 41, which may be used to hang the first limiting edge 17. In this way, the auxiliary-support support portion 12 can provide the auxiliary support 200 with support force in the magnetic attraction direction of the magnetic mating surface 41 while facilitating the disassembly of the auxiliary support 200 from the auxiliary-support magnetic interface 10. Additionally, the support mating portion 42 is hanged and connected with the auxiliary-support support portion 12 via the second flange 44 and the first limiting edge 17, simplifying the structure while ensuring the support force.

Furthermore, the support mating portion 42 further includes a first flange 43 protruding in the magnetic attraction direction of the magnetic mating surface 41, and the first flange 43 and the second flange 44 are disposed on both sides of the magnetic mating surface 41 in the width direction; the auxiliary-support support portion 12 includes a second limiting edge 18, and the first flange 43 is disposed on a side of the second limiting edge 18 away from the second flange 44, so as to limit the auxiliary support 200 in the width direction of the magnetic mating surface 41. In addition, when the auxiliary support 200 is adhered to the rearview mirror for use, the first flange 43 may provide a large support force in the width direction of the magnetic mating surface 41, such that a heavy tablet PC can be adhered and serve as an external screen.

In the embodiments, the first flange 43 is overlapped and connected with the second limiting edge 18, and in combination with the hanging engagement between the second flange 44 and the first limiting edge 17, the auxiliary support 200 is limited in both sides of the auxiliary-support magnetic interface 10 in the width direction and cannot move, which may ensure the stability of the connection between the two while preventing the second flange 44 from detaching from the first limiting edge 17. In addition, the structure of the auxiliary-support support portion 12 and the supporting mating portion 42 is simple and easy to form and manufacture.

As shown in FIG. 7, when it is necessary to disassemble the auxiliary support 200, the magnetic docking portion 40 may be first rotated, using the first limiting edge 17 as a pivot point, toward a side away from the auxiliary-support magnetic interface 10 of the main support 100, for causing the first flange 43 to disengage from the second limiting edge 18. Then, the auxiliary support 200 is moved along the width direction of the magnetic mating surface 41 toward a side away from the first flange 43, for causing the first limiting edge 17 to disengage from the second flange 44. That is, the computer stand can easily remove the auxiliary support 200 in a specific manner. During normal use, the auxiliary support 200 is not easily detached from the main support 100, which improves the convenience of disassembly and mounting of the auxiliary support 200 relative to the main support 100, and further improves the connection stability between the auxiliary support 200 and the main support 100.

Furthermore, as shown in FIG. 7, the magnetic docking portion 40 is embedded with a main magnetic attachment member 45 and a side magnetic attachment member 46 extending along the length direction of the magnetic docking portion 40, where the main magnetic attachment member 45 is disposed facing the auxiliary-support magnetic surface 11 in the magnetic attraction direction of the auxiliary-support magnetic surface 11; the side magnetic attachment member 46 is adjacent to the second flange 44 and is disposed in correspondence with and facing the first limiting edge 17.

In the embodiments, the main magnetic attachment member 45 is configured to provide magnetic attraction to the magnetic mating surface 41. By adding the side magnetic attachment member 46 to the magnetic docking portion 40 of the auxiliary-support, where the side magnetic attachment member 46 is adjacent to the second flange 44 and is disposed in correspondence with and facing the first limiting edge 17, the tightness of the engagement between the first limiting edge 17 of the main support 100 and the second flange 44 of the auxiliary support 200 may be increased. Further, through the clicking sound and tactile sensation of the side adsorption, the feedback and confirmation of the first limiting edge 17 being adsorbed into place are increased.

Specifically, as shown in FIGS. 4 and 5, the magnetic docking portion 40 further includes a first flange 43 and a second flange 44 disposed on both sides of the magnetic mating surface 41 in the width direction, where the first flange 43 protrudes along the magnetic attraction direction, and the second flange 44 protrudes along the width direction of the magnetic mating surface 41. The auxiliary-support magnetic interface 10 includes a first limit slot 13 and a second limit slot 14 to form two auxiliary-support support portions 12, and the first flange 43 is adapted to be embedded in the first limit slot 13; the second limit slot 14 is disposed on a peripheral edge of the main support 100, and the second flange 44 is adapted to be embedded in the second limit slot 14 along the width direction of the magnetic mating surface 41.

In the embodiments, the first limit slot 13 and the second limit slot 14 both extend along the length direction of the auxiliary-support magnetic interface 10, and the first flange 43 and the second flange 44 both extend along the length direction of the auxiliary-support magnetic interface 10, thereby increasing the mating area between the first flange 43 and the first limit slot 13 to enhance mating stability and increasing the mating area between the second flange 44 and the second limit slot 14 to enhance mating stability.

The first flange 43 cooperates with the first limit slot 13 to limit the movement of the auxiliary support 200 in the width direction (i.e., the left-right direction) of the magnetic mating surface 41, thereby preventing the auxiliary support 200 from detaching from the main support 100 in the left-right direction. The second flange 44 cooperates with the second limit slot 14 to limit the movement of the auxiliary support 200 in the magnetic attraction direction (i.e., the front-rear direction), thereby preventing the auxiliary support 200 from detaching from the main support 100 toward the rear.

It should be noted that when it is necessary to remove the auxiliary support 200 from the auxiliary-support magnetic interface 10, the auxiliary support 200 may be rotated backward around the first flange 43, with the first flange 43 as an axis, causing the second flange 44 to disengage from the second limit slot 14 first during the rotation of the auxiliary support 200. Once the second flange 44 is disengaged from the second limit slot 14, the first flange 43 can naturally disengage from the first limit slot 13, thereby achieving the disassembly of the auxiliary support 200.

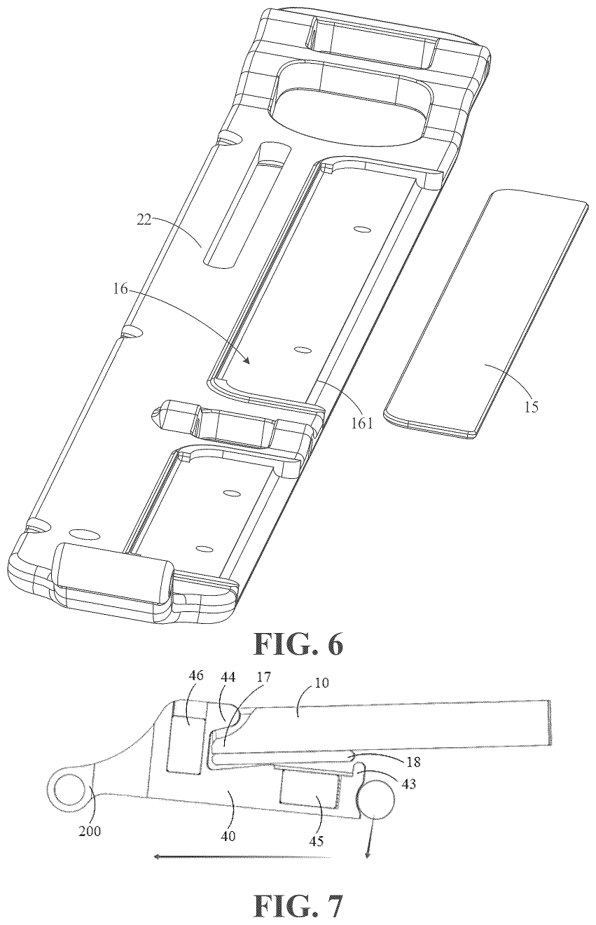

As an example, as shown in FIG. 6, the auxiliary-support magnetic interface 10 includes a magnetic member 15 and a magnetic groove 16 defined on the bracket 20; a bottom wall of the magnetic groove 16 is arranged with a mounting platform 161, the magnetic member 15 is fixed to the mounting platform 161, and the auxiliary-support magnetic surface 11 is disposed on the magnetic member 15; the magnetic member 15 and a slot wall of the magnetic groove 16 enclose to define the first limit slot 13 and the second limit slot 14.

The above configuration may simplify the specific formation method of the first limit slot 13 and the second limit slot 14 and improve the effective utilization rate of the magnetic member 15, enabling the magnetic member 15 to limit the movement of the auxiliary support 200 while attracting it, thereby making the mating relationship between the auxiliary support 200 and the magnetic member 15 more compact.

Specifically, as shown in FIG. 5, the second limit slot 14 includes a bottom wall formed on the magnetic member 15, and a top wall and a side wall that are located inside the magnetic groove 16 and have an arc-shaped transition. A spacing between the top wall of the second limit slot 14 and the second flange 44 gradually increases away from the first flange 43. In this way, during a mating process between the auxiliary support 200 and the auxiliary-support magnetic interface 10, the second flange 44 and the second limit slot 14 can more easily engage and lock into position, thereby improving the ease of mounting of the auxiliary support 200 at the auxiliary-support magnetic interface 10. Additionally, this design may facilitate the removal of the auxiliary support 200 from the auxiliary-support magnetic interface 10.

For example, as shown in FIG. 2, the length of the auxiliary-support magnetic interface 10 is greater than the length of the magnetic mating surface 41 such that the auxiliary support 200 can slide magnetically along the length direction of the auxiliary-support magnetic interface 10. In this way, the height position of the auxiliary support 200 relative to the main support 100 can be adjusted, such that the height position of the mobile phone placed on the auxiliary support 200 relative to the computer placed on the main support 100 can be adjusted. During the adjustment of the position of the auxiliary support 200, the auxiliary-support support portion 12 can guide the auxiliary support 200 to avoid misalignment of the auxiliary support 200.

Specifically, as shown in FIG. 3, the auxiliary support 200 includes a first plate 200A and a second plate 200B that are damped hinged to each other, where the first plate 200A is arranged with the magnetic docking portion 40, and the second plate 200B is arranged with a mobile-terminal magnetic portion 50. The auxiliary support 200 can be connected to the auxiliary-support magnetic interface 10 through the magnetic docking portion 40, and the mobile-terminal magnetic portion 50 can magnetically fix the mobile phone, simplifying the method of securing the mobile phone. The first plate and the second plate are damped hinged, allowing the opening angle of the second plate relative to the first plate to be adjusted, which means that the angle of the mobile phone placed on the mobile-terminal magnetic portion 50 relative to the support plate 22 can be adjusted, thereby enabling the user to adjust the mobile-terminal magnetic portion 50 to a preset position according to his/her preferences, and thus further enhancing the usability of the auxiliary support 200. Additionally, when the auxiliary support 200 is not in use, it can be folded to reduce its occupied space, facilitating storage of the auxiliary support 200.

The above is only some embodiments of the present disclosure, and does not limit the scope of the present disclosure. Any equivalent structural changes made under the concept of the present disclosure, or direct/indirect application in other related technical fields, are included in the scope of the present disclosure.

What is claimed is:

1. A computer stand, comprising:
a main support, configured to support a computer; wherein the main support is arranged with an auxiliary-support magnetic interface that is strip-shaped, and the auxiliary-support magnetic interface comprises an auxiliary-support magnetic surface and an auxiliary-support support portion that both extend along a length direction of the auxiliary-support magnetic interface;
wherein the auxiliary-support magnetic surface is configured for a magnetic connection with an auxiliary support; at least one of two sides of the auxiliary-support magnetic surface along a width direction is arranged with the auxiliary-support support portion; the auxiliary-support support portion is configured for a separable limit-mating with the auxiliary support and is further configured to provide a support force to the auxiliary support around a length direction of the auxiliary-support magnetic surface.

2. The computer stand according to claim 1, wherein the two sides of the auxiliary-support magnetic surface along the width direction are each arranged with the auxiliary-support support portion.

3. The computer stand according to claim 2, wherein for two of the auxiliary-support support portions on the two sides of the auxiliary-support magnetic surface, one of the two auxiliary-support support portions is configured to provide the support force to the auxiliary support around the length direction of the auxiliary-support magnetic surface, and the one of the two auxiliary-support support portions and the other of the two auxiliary-support support portions cooperate together to limit the auxiliary support along the width direction of the auxiliary-support magnetic surface.

4. The computer stand according to claim 1, wherein the main support comprises two brackets that are arranged side-by-side and a length-adjustable frame disposed between the two brackets;
each of the two brackets comprises a support plate; the support plate extends to form a strip-shape;
each of the two brackets is arranged with a steering-wheel mounting portion for hanging the computer stand on a steering wheel;
two of the support plates of the two brackets are connected by the length-adjustable frame.

5. The computer stand according to claim 4, wherein the support plate comprises a support surface for supporting a computer; the auxiliary-support magnetic interface is arranged on a surface of the support plate avoiding the support surface, and the length direction of the auxiliary-support magnetic interface is consistent with a length direction of the support plate.

6. The computer stand according to claim 5, wherein each of the two brackets further comprises a base plate and a support arm disposed between the base plate and the support plate, and the base plate extends to form a strip-shape; a hinged end of the base plate is hinged to an end of the support plate, and the base plate is arranged with the steering-wheel mounting portion on the hinged end; an end of the support arm is hinged to one of the base plate or the support plate, and another end of the support arm is inserted into the other of the base plate or the support plate.

7. The computer stand according to claim 5, wherein the support plate comprises a mounting back surface opposite the support surface;
the auxiliary-support magnetic interface is disposed on the mounting back surface; or, the auxiliary-support magnetic interface is disposed at a connection between the mounting back surface and a side surface of the support plate.

8. The computer stand according to claim 7, wherein at least one of the auxiliary-support magnetic interfaces is arranged on each of the two support plates.

9. The computer stand according to claim 1, further comprising a second auxiliary support for supporting a mobile terminal; wherein the second auxiliary support is arranged with a magnetic docking portion adapted to the auxiliary-support magnetic interface, and the magnetic docking portion comprises a magnetic mating surface and a support mating portion; the magnetic mating surface is magnetically mated with the auxiliary-support magnetic surface, and the support mating portion is limitingly mated with the auxiliary-support support portion along at least one of a width direction or a magnetic attraction direction of the magnetic mating surface.

10. The computer stand according to claim 9, wherein the support mating portion comprises a second flange disposed on a side of the magnetic mating surface along the width direction of the magnetic mating surface, and the second flange protrudes along the width direction of the magnetic mating surface and is spaced apart from the magnetic mating surface in the magnetic attraction direction.

11. The computer stand according to claim 10, wherein the auxiliary-support support portion comprises a first limiting edge that is sandwiched between the second flange and the magnetic mating surface.

12. The computer stand according to claim 11, wherein the support mating portion further comprises a first flange protruding along the magnetic attraction direction of the magnetic mating surface; the first flange is disposed on one of two sides of the magnetic mating surface in the width direction of the magnetic mating surface, and the second flange is disposed on the other of the two sides of the magnetic mating surface in the width direction of the magnetic mating surface.

13. The computer stand according to claim 12, wherein the auxiliary-support support portion further comprises a second limiting edge, and the first flange is disposed on a side of the second limiting edge away from the second flange, for limiting the auxiliary support in the width direction of the magnetic mating surface.

14. The computer stand according to claim 13, wherein the magnetic docking portion is embedded with a main magnetic attachment member and a side magnetic attachment member that both extend along a length direction of the magnetic docking portion, and the main magnetic attachment member is disposed facing the auxiliary-support magnetic surface in a magnetic attraction direction of the auxiliary-support magnetic surface; the side magnetic attachment member is adjacent to the second flange and is disposed in correspondence with and facing the first limiting edge.

15. The computer stand according to claim 13, wherein auxiliary-support magnetic interface comprises a first limit slot and a second limit slot to form two of the auxiliary-support support portions, and the first flange is adapted to be embedded in the first limit slot; the second limit slot is disposed on a peripheral edge of the main support, and the second flange is adapted to be embedded in the second limit slot along the width direction of the magnetic mating surface.

16. The computer stand according to claim 15, wherein the first limit slot and the second limit slot both extend along the length direction of the auxiliary-support magnetic interface, and the first flange and the second flange both extend along the length direction of the auxiliary-support magnetic interface.

17. The computer stand according to claim 15, wherein the auxiliary-support magnetic interface further comprises a magnetic member and a magnetic groove defined on a bracket of the main support; a bottom wall of the magnetic groove is arranged with a mounting platform, the magnetic member is fixed to the mounting platform, and the auxiliary-support magnetic surface is disposed on the magnetic member; the magnetic member and a slot wall of the magnetic groove enclose to define the first limit slot and the second limit slot.

18. The computer stand according to claim 17, wherein the second limit slot comprises a bottom wall formed on the magnetic member, and a top wall and a side wall that are located inside the magnetic groove and have an arc-shaped transition; a spacing between the top wall of the second limit slot and the second flange gradually increases along a direction away from the first flange.

19. The computer stand according to claim 9, wherein a length of the auxiliary-support magnetic interface is greater than a length of the magnetic mating surface, and the second auxiliary support is caused to be slidable magnetically along the length direction of the auxiliary-support magnetic interface.

20. The computer stand according to claim 9, wherein the second auxiliary support comprises a first plate and a second plate that are damped hinged to each other; the first plate is arranged with the magnetic docking portion, and the second plate is arranged with a mobile-terminal magnetic portion.
